(19) United States
(12) Patent Application Publication
(10) Pub. No.: US 2025/0171678 A1
(43) Pub. Date: May 29, 2025

(54) ONE-SACK GEOPOLYMER COMPOSITIONS

(71) Applicant: Schlumberger Technology Corporation, Sugar Land, TX (US)

(72) Inventors: Andrey Vladimirovich Yakovlev, Houston, TX (US); Mark Meade, Katy, TX (US); Nathan Fischer, Sugar Land, TX (US); Yeukayi Nenjerama, Sugar Land, TX (US); Randy Tercero, La Porte, TX (US); Christopher Parton, Rosenberg, TX (US); Veronica Richter McDonald, Sugar Land, TX (US); Roderick Pernites, Spring, TX (US); Valerie Gisele Helene Lafitte, Suger Land, TX (US)

(21) Appl. No.: 18/727,015

(22) PCT Filed: Jun. 27, 2023
(86) PCT No.: PCT/US2023/026349

§ 371 Date: Jul. 5, 2024

Related U.S. Application Data
(60) Provisional application No. 63/483,470, filed on Feb. 6, 2023.
(60) Provisional application No. 63/367,097, filed on Jun. 27, 2022.

(51) Int. Cl. C09K 8/467; C04B 14/04; C04B 22/06; C04B 22/10; C04B 24/38; C04B 28/00; C04B 103/10; C04B 103/20; C04B 103/44; E21B 33/138

(52) U.S. Cl. CPC C09K 8/467; C04B 14/045; C04B 22/064; C04B 22/10; C04B 24/383; C04B 28/006; E21B 33/138; C04B 2103/10; C04B 2103/20; C04B 2103/44

(57) ABSTRACT

Geopolymer precursor compositions are presented that are useful for cementing a subterranean well, among other uses. The precursor compositions are dry mixtures that have an aluminosilicate source and an activator. The activator is an alkalinity source that is safe to store, transport, and blend with an aluminosilicate source. The activator may be a hydroxide-free activator. A geopolymer slurry is formed by adding water to the dry geopolymer precursor compositions. Such slurries have suitable characteristics for use in cementing applications that use pumpable mixtures.

### CROSS-REFERENCE TO RELATED APPLICATIONS

This application claims benefit of U.S. Provisional Patent Application Ser. No. 63/367,097, filed Jun. 27, 2022, and of U.S. Provisional Patent Application Ser. No. 63/483,470, filed Feb. 6, 2023, each of which is entirely incorporated herein by reference.

### FIELD

This application for patent relates to geopolymer compositions. More particularly the invention relates to the use of geopolymer compositions that do not use strong alkaline solutions to activate polymerization.

### BACKGROUND

Geopolymers are a class of materials that are formed by chemical reaction of various aluminosilicates, oxides, and silicates to form an amorphous three-dimensional framework cement-like structure. The term geopolymer was proposed and first used by J. Davidovits. His work is described in Davidovits, J: “Synthesis of New High-Temperature GeoPolymers for Reinforced Plastics/Composites.’ Society of Plastics Engineers, IUPAC International Symposium on Macromolecules, Stockholm (1976). Other terms have been used to describe materials synthesized utilizing a similar chemistry, such as alkali-activated cement, geocement, alkali-bonded ceramic, inorganic polymer, hydroceramic. In the following description, the term geopolymer will be used.

Geopolymers have been investigated for use in several applications, including as concrete systems within the construction industry, as refractory materials and as encapsulants for hazardous and radioactive waste streams. Geopolymers are also recognized as being rapid setting and hardening materials. They exhibit superior hardness and chemical stability. The preparation of geopolymers generally involves mixing a blend of reactive solid materials and activating the polymerization reaction by adding an alkaline solution. Typically, the slurry mixture is then applied and allowed to harden in place. In construction, faster hardening is usually valued.

In the hydrocarbon industry, cement-like materials are used to line wells to provide isolation and structural support within the well. Use of cement-like materials in hydrocarbon wells presents unique challenges. The slurry mixture precursor is typically pumped over long distances to the location where the mixture is to set, so the mixture must be pumpable without undue burden on equipment. Additionally, ambient conditions encountered in a typical hydrocarbon well are much more extreme than those encountered in a typical construction application. Further, the large vertical extent of hydrocarbon well applications presents challenges of density, temperature, and pressure not faced in the construction industry. Other applications, like plugs, squeeze, and injector wells for water or carbon dioxide, also require a cementitious precursor to be pumped to an application site, so geopolymer compositions find broad use where pumping is required.

While geopolymers have been found useful tools for cementing subterranean wells, and in other applications requiring pumping a cementitious precursor, handling of alkaline solutions that are prepared by adding alkaline materials to water to mix geopolymer slurries is problematic. The practice of adding alkaline materials to water prior to mixing geopolymer slurries requires extra equipment and transportation of volumes of liquid to the well site. Such practices also bring operating concerns related to the characteristics of such materials. For example, adding alkali metal hydroxide activator to water releases heat and causes strong temperature rise in the prepared alkaline solution that complicates preparation of the geopolymer slurry and can cause unpredictable variation in setting and gelation performance. It would be useful to find geopolymer blends that can be used for lining hydrocarbon wells and for other uses such as construction uses, but that do not need strong alkaline solutions to be delivered to a well or construction site to create a slurry mixture.

### SUMMARY

Embodiments described herein provide a method of cementing a subterranean well, comprising mixing a dry geopolymer precursor, comprising an aluminosilicate source and an activator, with a non-activating water material to form a geopolymer slurry; pumping the geopolymer slurry into a subterranean well; and hardening the geopolymer slurry into a solid geopolymer within the subterranean well.

Other embodiments described herein provide a method of cementing, comprising adding activator-free water to a dry geopolymer precursor composition comprising an aluminosilicate source and an activator to form a geopolymer slurry; pumping the geopolymer slurry to a cementing destination; and hardening the geopolymer slurry into a solid geopolymer at the cementing destination.

Other embodiments described herein provide a method of cementing a subterranean well, comprising mixing a dry geopolymer precursor, comprising an aluminosilicate source and an activator, with a non-activating water material to form a geopolymer slurry; pumping the geopolymer slurry into a subterranean well; and hardening the geopolymer slurry into a solid geopolymer within the subterranean well, wherein the aluminosilicate source is fly ash, volcanic ash, ground blast furnace slag, calcined or partially calcined clay, aluminum-containing silica fume, natural aluminosilicate, synthetic aluminosilicate glass powder, zeolite, scoria, allophone, bentonite, red mud, calcined red mud, pumice, or a combination thereof, and wherein the activator is a solid alkali metal silicate M₂xSi_{y}O_{2y+x} where x is 1, 2, or 3 and y is 1 or 2, or a combination of thereof, or the activator is a mixture of an alkaline earth metal hydroxide, an alkaline earth metal oxide, an alkaline earth metal peroxide, or a combination of thereof with an alkali metal salt selected from the group consisting of M₂CO₃, M₂SO₄, M₂SO₃, M₃PO₄, M₂C₂O₄, M₂ₓSi_{y}O_{2y+x} where x is 1, 2, or 3 and y is 1 or 2, MF, M₂SiF₆, MIO₃, M₂MoO₄, where M is, Li, Na, K, Rb, or Cs, or a combination thereof.

Other embodiments described herein provide a method, comprising mixing a dry geopolymer precursor, comprising an aluminosilicate source that is at least 18% by weight calcium oxide and a hydroxide-free activator, with a non-activating water material to form a geopolymer slurry; disposing the geopolymer slurry at a setting location; and hardening the geopolymer slurry into a solid geopolymer at the setting location.

Other embodiments described herein provide a dry geopolymer precursor that reacts with a non-activating water material to form a geopolymer material, the dry geopolymer precursor comprising an aluminosilicate source and a solid activator.

Other embodiments described herein provide a method, comprising obtaining a dry geopolymer precursor comprising an aluminosilicate source and an activator; mixing the dry geopolymer precursor with a non-activating water material to form a geopolymer slurry; disposing the geopolymer slurry at a setting location; and hardening the geopolymer slurry into a solid geopolymer at the setting location.

### BRIEF DESCRIPTION OF THE DRAWINGS

FIG. 1 is a graph showing compression strength of various geopolymers according to embodiments described herein.

FIG. 2 is a graph showing compression strength of various geopolymer according to other embodiments described herein.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions are made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the disclosure and this detailed description, each numerical value should be read once as modified by the term “about” (unless already expressly so modified), and then read again as not so modified unless otherwise indicated in context. The term “about” should be understood as any amount or range within 10% of the recited amount or range (for example, a range from about 1 to about 10 encompasses a range from 0.9 to 11). Also, in the summary and this detailed description, it should be understood that a concentration range listed or described as being useful, suitable, or the like, is intended that any concentration within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, even if specific data points within the range, or even no data points within the range, are explicitly identified or refer to a few specific data points, it is to be understood that inventors appreciate and understand that any data points within the range are to be considered to have been specified, and that inventors possessed knowledge of the entire range and the points within the range.

Regarding chemical formulas, it should be noted that measurements may not conform precisely to the chemical formulas described herein due to various sources of error that can affect real-world testing. The chemical formulas described herein should therefore be understood as expressing the nominal chemical makeup of compounds, where real-world testing may show close, but not exact, conformity to the formulas.

As used herein, “embodiments” refers to non-limiting examples disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Geopolymer materials, and other alkali activated materials, are formed by disposing an aluminosilicate source and an alkali activator in a water mixture having high pH. Examples of aluminosilicate sources that can be used include (but are not limited to) ASTM Class C fly ash, ASTM Class F fly ash, fly ash not classified by ASTM, volcanic ash, volcanic glass, slag, ferrous slag, ferroalloy slag, non ferrous slag, such as copper slag, nickel slag, tin slag, zinc slag, and the like, blast furnace slag, basic oxygen furnace slag, electric arc furnace slag, and ground slags, such as ground blast furnace slag, ground granulated blast furnace slag (GGBS), diatomaceous earths, pumice, and calcined clays, which may be partially or fully calcined clays (metakaolin is a partially calcined clay), aluminum-containing silica fume, natural aluminosilicate, feldspars, which may be dehydrated, alumina and silica sols, synthetic aluminosilicate glass powder, zeolite, scoria, allophone, bentonite, pumice, red mud, which may be calcined. Other examples of aluminosilicates with similar activity are ashes produced by combustion of some forest or agricultural industry by-products commonly known as biomass ash, or more specifically biomass fly ash, from various sources such as witchgrass ash, walnut shell ash, rice husk ash, and the like. These materials contain a significant proportion of an amorphous aluminosilicate phase, which reacts in strong alkaline solutions. The more common aluminosilicates are fly ash, metakaolin and blast furnace slag. Mixtures of two or more aluminosilicate sources may also be used if desired. In addition, alumina and silica may be added separately, for example as a blend of bauxite and silica fume. Other amorphous silica sources can also be used, which may include soda-lime glass dust, borosilicate glass dust, microsilica, fumed silica, precipitated silica, nanosilica, rice husk ash, or a combination thereof. It should be noted that some of the aluminosilicate sources mentioned above, such as GGBS and ASTM Class C fly ash, also contain calcium oxide, so these materials can also be considered activator sources. Suitable aluminosilicate sources for purposes here can have at least 2%, at least 7%, at least 12%, at least 18%, or at least 25% by weight calcium oxide. These aluminosilicate sources become reactive when placed in strongly alkaline environments, typically at pH greater than 11. The aluminosilicate sources described above react under such conditions to form geopolymers and other materials derived from alkali activated materials. Binder components such as Portland cement, kaolin, bauxite, aluminum oxide, and aluminum hydroxide can also be included.

Geopolymer precursor compositions in one sack for use in cementing subterranean wells, such as hydrocarbon wells, injector wells, or plug and abandon or squeeze activity, or for other applications above or below ground, such as construction applications, are described herein. The geopolymer precursor compositions described herein are such that non-activating water materials can be used to prepare a settable slurry mixture for use at a target location. A non-activating water material, for purposes herein, is a water material having pH less than about 11. Water, free of any alkaline activator, can be used. Thus, the geopolymer precursor compositions described herein can be such that only water, free of any activators, is needed to prepare a settable slurry mixture for deployment into a subterranean well, and the resulting slurry mixture has controlled setting time, viscosity profile, and density profile suitable for pumping into such a well. Thus, geopolymer precursor compositions that can be safely handled and mixed with activator-free water to prepare a settable slurry for lining a hydrocarbon well are described herein. Upon addition of appropriate amounts of non-activating water material to the dry ingredients, the geopolymer slurry formed thereby can be pumpable, so such compositions can be pumped into subterranean wells or in any application where pumping a cementitious material is needed, such as for grouting applications related to construction at a pipeline location or for underground or subsea electrical installations. In some cases, the water used to mix with the dry blend, containing one or more activators, is not activator-free, but can contain activator species in solution, which might be insufficient to achieve setting of a geopolymer slurry. The slurries described herein are made using dry ingredients that include activators as dry ingredients, so the water used to make the slurry can be free of any activators. These dry activators can be hydroxide-free.

Such compositions also remove the need to transport large volumes of caustic liquid ingredients to a well site for mixing geopolymer slurries, and to mix such liquid ingredients at the well site (requiring equipment for such mixing), reducing the overall equipment footprint at the well site and incrementally reducing the environmental burden of operating equipment at the well site. Such compositions also generate less heat on mixing with water, allowing for more operating flexibility because cooling time is not needed. For example, using the compositions described herein, slurries can be mixed and pumped “on-the-fly,” without the need to mix liquid ingredients and wait for them to cool, or slurries can be batch-mixed and pumped with no limitation imposed by the need to moderate heating upon dissolution.

A dry geopolymer precursor composition typically includes an aluminosilicate source such as those described above, an activator or mixture of activators, and one or more density, viscosity profile modifiers, retarders, and/or accelerators to render the slurry suitable for pumping downhole and setting at a target location within the well before substantial hardening takes place after a suitable amount of water, which may be activator-free or may have insufficient activator concentration to polymerize a geopolymer slurry, is added to make the slurry. In conventional practice, a geopolymer slurry is formed by adding an alkali metal or alkaline earth hydroxide solution to a dry mixture. In the slurries described herein, such solutions are not needed, and the geopolymer precursor composition is a dry material that contains a solid particulate source of alkalinity that can be mixed with water containing no activator, or an amount of activator insufficient to form a suitable geopolymer, to raise the pH of the slurry to an activation level.

The activators used herein are generally dry materials, to which water or a non-activating water material is added. The activator used herein can be a metal silicate M₂ₓSi_{y}O_{2y+x} where x is 1, 2, or 3 and y is 1 or 2 (for example silicates, metasilicates, orthosilicates, and pyrosilicates), where M can be Li, Na, K, Rb, or Cs, or combination thereof. The metal silicates are used in an amount to provide a pH of 11 or higher to activate aluminosilicate components for polymerization to occur and form the geopolymer.

The activators used herein can include an alkaline earth metal hydroxide, such as Ca(OH)₂, Sr(OH)₂, Mg(OH)₂ and/or Ba(OH)₂; or alkaline earth metal oxide, such as CaO, SrO, MgO and/or BaO or a combination thereof, or alkaline earth metal peroxide, such as MgO₂ and CaO₂ or a combination thereof; and at least one alkali metal salt such as a metal carbonate M₂CO₃, metal sulphate M₂SO₄, metal sulphite M₂SO₃, metal phosphate M₃PO₄, metal oxalate M₂C₂O₄, metal silicate M₂ₓSi_{y}O_{2y+x} where x is 1, 2, or 3 and y is 1 or 2 (for example silicates, metasilicates, orthosilicates, and pyrosilicates), metal fluoride MF, metal hexafluoridosilicate M₂SiF₆, metal iodate MIO₃, metal molybdate M₂MoO₄, where M can be Li, Na, K, Rb, or Cs, where such salts can have a combination of different metals and a combination of different anions. Lime and hydrated lime are examples of materials that contain calcium oxide and/or calcium hydroxide. Hydrogenated metal salts, such as MHCO₃, MHSO₄, MHPO₄, MHC₂O₄, M₂HPO₄, MH₂PO₄, and MHSO₃ can also be used, alone or in combination with other activators described herein, where M is as listed above. These activators raise pH in a slurry upon addition of water such that the aluminosilicates in the geopolymer precursor composition dissolve and begin to react to form geopolymer. Alkali metal oxide and hydroxide solids are not used as activators herein due to extremely exothermic reactions of such materials with water. The activators may further include Portland cement, cement kiln dust, cement by-pass dust or a combination thereof.

The solid activators described above are particulate materials that are blended with the aluminosilicate source to make a dry particulate blend. As noted above, a combination of such activators can be used. The solid activators are typically added in a quantity that is 2 to 40 parts per hundred based on the weight of the dry geopolymer precursor particulate blend, for example 4 to 20 parts per hundred or 4 to 40 parts per hundred based on the weight of the total dry geopolymer precursor particulate blend. The solid activator content of the precursor composition is selected to provide a thickening time suitable for deploying the slurry downhole along with acceptable compressive strength after passage of a requisite time period such as 24 hours. For example, the compositions described herein can be formulated to have a thickening time (e.g. time to thickness of 70 Bearden consistency units) of at least −2 hours. The amount of solid activator used depends on the type of solid activator, the type of aluminosilicate source used, the desired thickening time, and the desired hardness of the final geopolymer. Use of the activators described herein can provide the capability to make alkaline activated materials, such as geopolymers, in the absence of added alkali metal or alkaline earth metal hydroxides.

Thickening time of the geopolymer slurry formed by adding water to the precursor mixtures described herein can be influenced by adding retarders and accelerators. Several retarders may delay the setting and hardening of geopolymer systems. Retarders such as sodium pentaborate decahydrate, borax, sucrose, boric acid, lignosulphonates, sodium glucoheptonate, tartaric acid, citric acid, or phosphorus containing compounds such as phosphoric acid, salts thereof, or mixtures thereof can be added to the geopolymer precursor particulate mixture in amounts of 0.01 to 5 part per hundred by weight of the total particulate precursor mixture. The amount of retardation of the polymerization reaction, and the setting of the slurry, depends on the type of raw materials used for the slurry and the type and relative quantity of retarder used. Adding too much retarder reagent to a geopolymer slurry can cause the slurry to remain unhardened by interfering with the polymerization reaction so the geopolymer does not set. In other embodiments a retarder solution can be added to the carrier fluid or to the geopolymer slurry, or both. By this means, the same geopolymer precursor could be pumped into different sections of a well and setting time of geopolymer slurry in the different sections can be controlled through addition of a different amount of the retarder solution.

Accelerators can also be added to the geopolymer precursor particulate mixture in amounts up to about 0.01-10, such as 1-5, parts per hundred weight of the total particulate precursor mixture. The amount of acceleration of the polymerization reaction, and the setting of the slurry, depends on the type of raw materials used for the slurry and the type and relative quantity of accelerating reagent used. Adding too much accelerator to a geopolymer slurry can cause the slurry to thicken too quickly making it difficult to deploy the slurry to target locations downhole. It should be noted that the retarders and accelerants described herein can be included as particulate materials in the geopolymer precursor composition, or such reagents can be added to water before the water is added to a geopolymer precursor composition described herein.

Geopolymer slurries for use in well lining applications typically have a slurry density range from 0.84 g/cm³ (7 lbm/gal) to 2.87 g/cm³ (24 lbm/gal), such as 1.32 g/cm³ (11 lbm/gal) to 2.4 g/cm³ (20 lbm/gal) or 1.32 g/cm³ (11 lbm/gal) to 2.16 g/cm³ (18 lbm/gal), for example 1.36 g/cm³ (11.3 lbm/gal) to 1.90 g/cm³ (15.8 lbm/gal). The slurry density can be influenced by quantity of water added and/or by adding density modifiers. Water typically makes up from about 20% by weight to about 60% by weight of a geopolymer slurry. Density modifiers can include density increasing particles and density lowering particles. Low-density particles may be added to the geopolymer precursor particulate mixture to achieve lower slurry densities for a given amount of water added, or heavy particles may be added to achieve higher slurry densities. The lightweight or low-density particles may have densities lower than 2 g/cm³, or lower than 1.3 g/cm³. Examples include hollow glass or ceramic microspheres (cenospheres), plastic particles such as polypropylene beads, rubber particles, uintaite (sold as GILSONITE™), vitrified shale, petroleum coke or coal or combinations thereof. The lightweight particles may be present in the compositions at concentrations between about 0.06 kg/L and 0.6 kg/L (20 lb/bbl and 200 lb/bbl). The particle size range of the low-density particles may be between about 38 μm and 3350 μm (6 mesh and 400 mesh). The heavy particles typically may have densities exceeding 2 g/cm³, or more than 3 g/cm³. Examples include hematite, barite, ilmenite, silica (e.g. crystalline silica sand), crushed granite and also manganese tetroxide commercially available under the trade names of MicroMax™ and MicroMax FF™.

Other additives, such as anti-foam agents, defoamers, silica, fluid-loss control additives, viscosifiers, dispersants, expanding agents, anti-settling additives or combinations thereof. Selection of the type and amount of additive largely depends on the nature and composition of the set composition, and those of ordinary skill in the art will understand how to select a suitable type and amount of additive for compositions herein.

The fluid-loss control agent may comprise a latex. The latex may be an alkali-swellable latex. The latex may be present in the compositions at a concentration between 0.02 UL and 0.3 UL or between 0.05 UL and 0.15 UL.

Viscosifiers may comprise diutan gum having a molecular weight higher than about 1×10⁶. The diutan gum may be present at a concentration between 0.14 g/L and 1.4 g/L (0.05 lbm/bbl and 0.5 lbm/bbl). In some cases, viscosifiers are present in the dry geopolymer precursor at a concentration of 0.1-5% by weight of the total dry geopolymer precursor. Other viscosifiers may comprise a polysaccharide material, which may be a biopolymer. Suitable polysaccharide biopolymers can include welan gum, a polyanionic cellulose (PAC), a carboxymethylcellulose (CMC), and combinations thereof. One or more polysaccharide materials, which may be biopolymers, may be present at a concentration between 0.14 g/L and 1.4 g/L (0.05 lbm/bbl and 0.5 lbm/bbl). The molecular weight of the polysaccharide material, which may be a biopolymer, may be between 100,000 and 1,000,000.

Carboxylic acids including gluconic acid and soluble salts thereof, glucoheptonic acid and soluble salts thereof, tartaric acid and soluble salts thereof, citric acid and soluble salts thereof, glycolic acid and soluble salts thereof, lactic acid and soluble salts thereof, formic acid and soluble salts thereof, acetic acid and soluble salts thereof, proprionic acid and soluble salts thereof, oxalic acid and soluble salts thereof, malonic acid and soluble salts thereof, succinic acid and soluble salts thereof, adipic acid and soluble salts thereof, malic acid and soluble salts thereof, nicotinic acid and soluble salts thereof, benzoic acid and soluble salts thereof, and ethylenediamine tetraacetic acid (EDTA) and soluble salts thereof may be included in the compositions as retarders or dispersants or both. Phosphoric acids may be present for the same purpose. Salts of these acids may also be employed. These materials may be present in the compositions at concentrations between 0.5 g/L and 10 g/L, or between 1 g/L and 5 g/L.

Expanding agents may comprise calcium sulphate hemihydrate, metal oxides such as MgO or combinations thereof. The expanding agents may be present in the compositions at concentrations between 0.01 kg/L and 0.2 kg/L of slurry, or between 0.05 and 0.1 kg/L.

The water added to form the geopolymer slurry can be activator-free water or part of an activator solution. In some cases, additional activator may be included with the water to make an incremental activator solution, which used alone without any other activators would be non-activating, that is added to the geopolymer precursor mixture to make the slurry, and/or added to the geopolymer slurry. For example, a geopolymer precursor mixture containing a solid activator may be mixed with a solution of an activator in water to form a geopolymer slurry having a target total amount of activator. In such cases, the solution can be a non-activating solution of alkali metal hydroxide MOH, alkaline earth metal oxide or hydroxide such as Ca(OH)₂, Sr(OH)₂, Mg(OH)₂. Ba(OH)₂, an alkali metal salt selected from the group consisting of M₂CO₃, M₂SO₄, M₃PO₄, M₂C₂O₄, M₂ₓSi_{y}O_{2y+x} where x is 1, 2, or 3 and y is 1 or 2, MF, M₂SiF₆, MIO₃, M₂MoO₄, where M is Li, Na, K, Rb, or Cs, or a combination thereof, that adds an incremental amount of activator to the activator present in the geopolymer precursor particulate mixture prior to blending with the solution. Because the geopolymer precursor mixture contains solid activator, the added activator solution can contain an amount of activator that alone would be insufficient to set the slurry, and thus would be non-activating, but when combined with the components released by reaction of the solid activator with water, results in desired setting of the slurry. In some embodiments, a first water volume, free of activator, can be added, and a second water volume comprising a non-activating water material that contains some activator can be added separately, in any order.

### Examples

Table 1 shows preparation of Examples A1-A3. These example compositions were prepared by adding GGBS, silica, barite, and sodium metasilicate activator to water, with other ingredients shown in Table 1.

TABLE 1

| | A1 | A2 | A3 |
|---|---|---|---|
| Slurry Density, g/cm³ | 1.68 (14.7) | 1.68 (14.7) | 1.98 (16.4) |
| (lbm/gal) | | | |
| GGBS (1^{st} source), g | 188 | 188 | |
| GGBS (2^{nd} source), g | | | 286 |
| Silica, g | 466 | 466 | |
| Barite, g | | | 443 |
| Sodium metasilicate, g | 45 | 45 | 49 |
| CMC viscosifier, g | | 5 | |
| Diutan gum, g | | | 0.5 |
| PEG anti-foam, g | 1 | 1 | 1 |
| Water, g | 340 | 340 | 372 |

The compositions shown in Table 1 can be prepared by mixing the dry ingredients together, and then adding water to complete the composition. The mixed dry ingredients can be stored, shipped, and otherwise handled in dry form, and then water can be added at the time the composition is to be deployed to make a geopolymer precursor slurry. The slurry can be made pumpable for deployment in a hydrocarbon well. In general, the dry geopolymer precursor described herein can be blended with water to make a geopolymer slurry that will develop into a geopolymer usable for many applications above and below ground, including applications such as hydrocarbon wells where the geopolymer slurry is to be pumped to a setting location. In other cases, the geopolymer slurry can be disposed at any setting location by any suitable means. Additional dry ingredients, as described above, can be added to the dry mixture for thickening time control, density or viscosity profile control, or other objectives.

Rheology of examples A1-A3 was measured after conditioning the mixtures at 60° C. (bottom hole circulating temperature, “BHCT”) according to API procedure RP 10B. Thickening time was measured at 60° C. and 2000 psi, compressive strength was measured after 24 hours by crushing 2″×2″ cubes of each material. The results are summarized in Table 2 (thickening time to 70 Bearden consistency units, “Bc,” are given).

TABLE 2

| | A1 | A2 | A3 |
|---|---|---|---|
| PV/Ty (after mixing) | 62/15 | 270/67 | 115/33 |
| 10″, 10′ gels (after | 14/115 | 29/108 | N/A |
| mixing) | | | |
| PV/Ty (after conditioning) | 60/13 | 242/32 | 118/24 |
| 10″, 10′ gels (after | 12/17 | 25/37 | 15/31 |
| conditioning) | | | |
| Free fluid, % | 1.0 | 0 | 0 |
| Thickening time, | 4:29 | N/M | 3:33 |
| 70 Bc (hh:mm) | | | |
| Compressive | N/M | 2330 | 1320 |
| strength after 24 | | | |
| hrs, psi | | | |
| Compressive | 2530 | N/M | 2270 |
| strength after 7 | | | |
| days, psi | | | |

Table 3 shows preparation of Examples A4-A8. These examples were prepared by blending fly ash, soda ash, glass bubbles, retarder, viscosifier, hydrated lime, silicate (e.g. sodium silicate or sodium metasilicate), soda-lime glass dust, and/or cement by-pass dust to form different dry mixtures, and then adding water containing anti-foam to the dry mixtures. The anti-foam is the only component added to the water prior to mixing the slurry.

TABLE 3

| | A4 | A5 | A6 | A7 | A8 | A9 |
|---|---|---|---|---|---|---|
| Slurry density g/cm³ | 1.77 | 1.77 | 1.77 | 1.77 | 1.77 | 1.39 |
| (lbm/gal) | (14.8) | (14.8) | (14.8) | (14.8) | (14.8) | (11.6) |
| Fly ash, g | 569.4 | 585.05 | 578.9 | 591.31 | 572.39 | 250.3 |
| Hydrated lime, g | 46.91 | 6.74 | 54.52 | 36.75 | 14.62 | 25 |
| Lime, g | | | | | | 9 |
| Cement by-pass | | 49.24 | | | | |
| dust, g | | | | | | |
| Soda ash, g | 56.94 | 58.51 | 57.89 | 59.13 | 57.24 | 36.30 |
| sodium | 0.75 | 0.75 | 0.75 | 0.45 | 0.75 | 1.25 |
| glucoheptonate, g | | | | | | |
| Phosphoric acid, | | | | 2.75 | | |
| 8% wt, g | | | | | | |
| Sodium | | | | | | 1.25 |
| lignosulfonate, g | | | | | | |
| Sodium | | | | | | 8.8 |
| metasilicate, g | | | | | | |
| Sodium | | | 17.25 | | | |
| Silicate(SS20-C), g | | | | | | |
| Sodium | | | | 30.24 | | |
| Silicate(SS20), g | | | | | | |
| Borosilicate glass | | | | | 49.84 | |
| dust, g | | | | | | |
| Water, g | 265.32 | 338.92 | 351.51 | 240.70 | 344.47 | 485 |
| PEG anti-foam, g | 1.07 | 1.1 | 1.09 | 1.11 | 1.07 | 0.5 |

The compositions shown in Table 3 can be prepared by mixing the dry ingredients together, and then adding water to complete the composition. While the anti-foam was added to Examples A4-A8 by adding the anti-foam to the water prior to mixing, the anti-foam can also be added to the dry mixture as a dry ingredient. The mixed dry ingredients can be stored, shipped, and otherwise handled in dry form, and then water can be added at the time the composition is to be deployed to make a geopolymer precursor slurry. The slurry is pumpable for deployment in a hydrocarbon well. In some cases, a geopolymer slurry is pumpable where the slurry has a slurry consistency lower than about 70 Bc as measured by a high-temperature, high-pressure consistometer, a yield value (Ty) lower than about 50 lbj/100 ft², or both.

Rheology of examples A4-A8 was measured after conditioning the mixtures at 48.9° C. (BHCT; 120° F.) according to API procedure RP 10B-2. Thickening time and ultrasonic cement analyzer (“UCA”) measurements were performed at 48.9° C. (120° F.) and 3000 psi, and compressive strength was measured utilizing non-destructive UCA methodology according to API procedure RP 10B-2. The results are summarized in Table 4.

TABLE 4

| | A4 | A5 | A6 | A7 | A8 | A9 |
|---|---|---|---|---|---|---|
| PV/Ty (after | 1.72/7.9 | 22.9/8.2 | 18.1/7.0 | 22.0/9.3 | N/M | 12.5/3.0 |
| mixing) | | | | | | |
| 10″, 10′ gels | 7/5/19.2 | 6.4/14.9 | 6.4/19.2 | 7.5/28.7 | N/M | 3.2/4 |
| (after mixing) | | | | | | |
| PV/Ty (after | 114/14.2 | 204.9/19.1 | 204.9/19.1 | 251/31.4 | N/M | 34/7 |
| conditioning) | | | | | | |
| 10″, 10′ gels | 10.6/21.3 | 14.9/25.6 | 14.9/25.6 | 16.0/39.4 | N/M | 5/24 |
| (after | | | | | | |
| conditioning) | | | | | | |
| Free fluid, % | 0 | 0 | 0 | 0 | N/M | 0 |
| Thickening | 3:39 | 3:17 | 3:15 | 2:51 | 2:21 | N/A |
| time, 70 Bc | | | | | | |
| (hh:min) | | | | | | |
| Compressive | 1891 | 1775 | 1754 | 1933 | 1795 | 360 |
| strength | | | | | | |
| after 24 hrs, | | | | | | |
| psi | | | | | | |

The examples above show that one-sack geopolymer precursor compositions can be made using solid activator materials that are safe to store, transport, and mix with water. The precursor compositions can be prepared at a well site to suitable density and rheology for pumping into a subterranean well such as a hydrocarbon well. The compositions then set in a suitable time period for use in cementing subterranean wells. Additionally, mixing water with these geopolymer precursor compositions generates only modest heat that will not adversely affect pumpability of the slurry by accelerating setting.

In some cases, a dry geopolymer precursor can have an aluminosilicate source and one or more activators that are hydroxide-free. The metal silicates mentioned above can be used as activators alone, without any other alkaline materials. Other materials that can be used as activators alone, without any other alkaline materials, include metal carbonates M₂CO₃, where M is Li, Na, K, Rb, or Cs. Soda ash and sodium metasilicate are materials that can be used to activate geopolymer slurries without adding hydroxide to the mixture. In some cases, a single hydroxide-free material, as described above, can be used to activate a geopolymer slurry. For example, soda ash can be used as a single hydroxide-free activator for a geopolymer slurry comprising GGBS. Although not wishing to be limited by theory, it is believed that the dry, hydroxide-free activators used herein in some cases, react in water to form hydroxide species that can polymerize the geopolymer slurry.

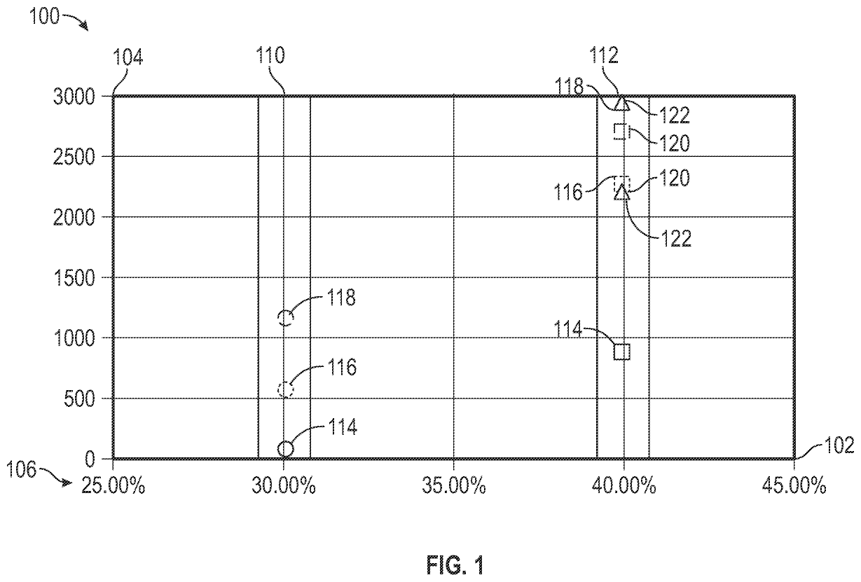

FIG. 1 is a graph 100 showing compression strength of various geopolymers made using GGBS and ASTM Class C fly ash as aluminosilicate sources and soda ash as the only activator. These geopolymers were each made using 0.04% by weight of diutan gum viscosifier, based on the weight of the aluminosilicate source, and 0.15% by weight of polynaphthalene sulfonate dispersant, based on the weight of the aluminosilicate source. The dry ingredients, including aluminosilicate source and dry activator, were blended, and the slurries were made by adding activator-free water and mixing. At 102, an axis of the graph 100 shows quantity of calcium oxide in the aluminosilicate source, with axis markings at 106. At 104, a second axis of the graph 100 shows compression strength in pounds per square inch. The data points showing results for ASTM Class C fly ash as the aluminosilicate source are grouped at 110 and the data points showing results for GGBS as the aluminosilicate source are grouped at 112. The fly ash used to make the geopolymers represented by the grouping 110 of data points contained 30.08% calcium oxide, and 59.59% calcium oxide plus silica, by weight. The GGBS used to make the geopolymers represented by the grouping 112 of data points contained 39.93% calcium oxide, and 72.23% calcium oxide plus silica, by weight. The geopolymers represented by the data points at 110 were made by subjecting a precursor based on ASTM Class C fly ash to curing at 81° C. for 168 hours, and the geopolymers represented by the data points at 112 were made by subjecting a GGBS-based precursor to curing at 81° C. for 24 hours, with two exceptions. The data points labeled 122 are for geopolymers made by subjecting a GGBS-based precursor to curing at 44° C. for 24 hours.

The geopolymers represented by the data points in FIG. 1 were made by compiling all the dry ingredients into a hydroxide-free dry mixture and adding water to the dry mixture to make the precursor slurry. For all these precursors, 0.02 gallons per sack of propylene glycol was added as a defoamer. The dry mixtures use different amounts of soda ash activator. The data points 114 represent geopolymers made using 2% by weight soda ash activator, based on the weight of the aluminosilicate source. The data points 116 represent geopolymers made using 4% by weight soda ash activator, based on the weight of the aluminosilicate source. The data points 120 represent geopolymers made using 6% by weight soda ash activator, based on the weight of the aluminosilicate source. The data points 118 represent geopolymers made using 8% by weight soda ash activator, based on the weight of the aluminosilicate source. All the geopolymer precursor slurries that produced the geopolymers of FIG. 1 were made to a density of 15.2 pounds per gallon.

The data of FIG. 1 shows that soda ash can be used as the sole activator for geopolymer precursors using GGBS and/or ASTM Class C fly ash as aluminosilicate sources. With these two aluminosilicate sources, using sufficient soda ash as a single hydroxide-free activator can result in a geopolymer having suitable compression strength for some applications. As shown in FIG. 1, using more activator generally results in a geopolymer having higher compression strength, up to a point. As also shown in FIG. 1, GGBS generally develops higher compression strength than ASTM Class C fly ash for a given activator concentration. Generally speaking, the data of FIG. 1 shows that using soda ash as a single activator for a dry hydroxide-free geopolymer precursor that reacts with water to form a geopolymer, where the soda ash is present in the dry geopolymer precursor at a concentration of 4% by weight or more, based on the total weight of the aluminosilicate source in the dry hydroxide-free geopolymer precursor, provides a geopolymer having suitable compression strength for some applications. With some aluminosilicate sources having higher calcium oxide content, for example at least 40% by weight of the aluminosilicate source, as little as 2% by weight soda ash, based on the weight of the aluminosilicate source, can provide a geopolymer having suitable compression strength for some applications.

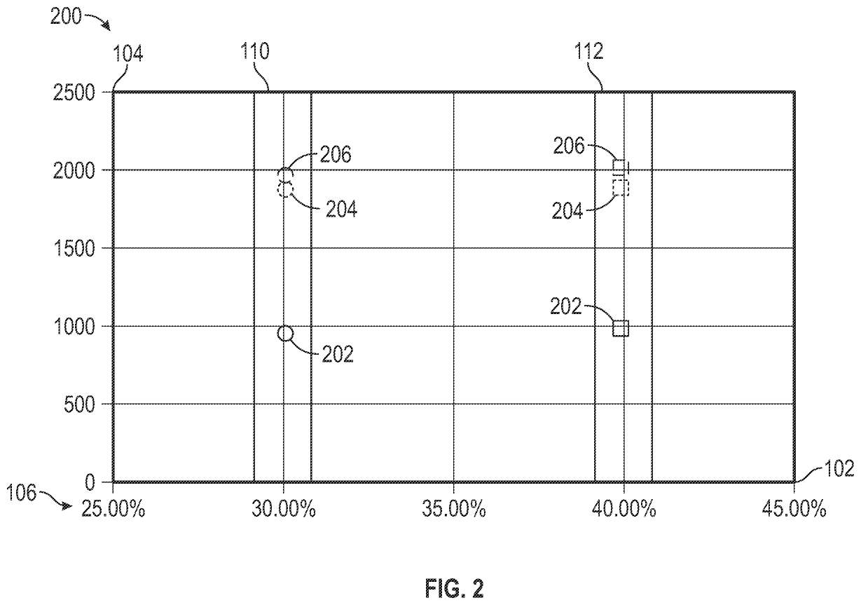

FIG. 2 is a graph 200 showing compression strength of various geopolymers made using the same GGBS and ASTM Class C fly ash materials from FIG. 1 as aluminosilicate sources and sodium metasilicate as the only activator. These geopolymers were each made using 0.04% by weight of diutan gum viscosifier, based on the weight of the GGBS, and 0.15% by weight of polynaphthalene sulfonate dispersant, based on the weight of the GGBS. The graph 200 has the same axes 102 and 104 as the graph 100, with the same label group 106, and the same data groupings 110 and 112. The geopolymers represented by the data points in the graph 200 were all cured at 81° C. for 24 hours.

As with FIG. 1, the geopolymers represented by the data points in FIG. 2 were made by compiling all the dry ingredients into a hydroxide-free dry mixture and adding activator-free water to the dry mixture to make the precursor slurry. For all these precursors, 0.02 gallons per sack of propylene glycol was added as a defoamer. The dry mixtures use different amounts of ASTM Class C fly ash activator. The data points 202 represent geopolymers made using 7.31% by weight sodium metasilicate activator, based on the weight of the aluminosilicate source. The data points 204 represent geopolymers made using 11% by weight sodium metasilicate activator, based on the weight of the aluminosilicate source. The data points 206 represent geopolymers made using 15% by weight sodium metasilicate activator, based on the weight of the aluminosilicate source. All the geopolymer precursor slurries that formed the geopolymers of FIG. 2 were made to a density of 15.2 pounds per gallon.

The data of FIG. 2 shows that sodium metasilicate can be used as the sole added activator for geopolymer precursors using GGBS and/or ASTM Class C fly ash as aluminosilicate sources. With these two aluminosilicate sources, using sufficient sodium metasilicate in a dry blend as a single hydroxide-free activator, to mix with activator-free water to form a geopolymer slurry, can result in a geopolymer having suitable compression strength for some applications. As shown in FIG. 2, using more activator generally results in a geopolymer having higher compression strength, up to a point. As also shown in FIG. 2, in contrast to the result in FIG. 1, GGBS and ASTM Class C fly ash generally develop similar compression strength for a given activator concentration. Generally speaking, the data of FIG. 2 shows that using sodium metasilicate as a single activator for a dry hydroxide-free geopolymer precursor that reacts with water to form a geopolymer, where the sodium metasilicate is present in the dry geopolymer precursor at a concentration of 7% by weight or more, based on the total weight of the aluminosilicate source in the dry hydroxide-free geopolymer precursor, provides a geopolymer having suitable compression strength for some applications.

The dry, hydroxide-free geopolymer precursors described above can be mixed with any of the additives described herein prior to adding water, or any of the additives described herein can be added to the geopolymer slurry formed by adding water after the water is added. Upon adding water, a geopolymer slurry is formed that can be deployed at a setting location by any suitable means, for example by pumping in certain embodiments, and allowed to harden into a geopolymer.

1. A method of cementing a subterranean well, comprising:
mixing a dry geopolymer precursor, comprising an aluminosilicate source and an activator, with a non-activating water material to form a geopolymer slurry;
pumping the geopolymer slurry into a subterranean well; and
hardening the geopolymer slurry into a solid geopolymer within the subterranean well.

2. The method of claim 1, wherein the activator is a solid alkali metal silicate M₂ₓSi_{y}O_{2y+x}, wherein x is 1, 2, or 3 and y is 1 or 2, and where M is Li, Na, K, Rb, Cs or a combination of thereof.

3. The method of claim 1, wherein the activator comprises a mixture of an alkaline earth metal hydroxide, an alkaline earth metal oxide, an alkaline metal peroxide, or a combination thereof, with an alkali metal salt selected from the group consisting of M₂CO₃, M₂SO₄, M₂SO₃, M₃PO₄, M₂C₂O₄, M₂ₓSi_{y}O_{2y+x} where x is 1, 2, or 3 and y is 1 or 2, MF, M₂SiF₆, MIO₃, M₂MoO₄, where M is Li, Na, K, Rb, or Cs, or a combination thereof.

4. The method of claim 3, wherein the activator further comprises Portland cement, cement kiln dust, cement by-pass dust or a combination thereof.

5. The method of claim 1, wherein the aluminosilicate source is fly ash, volcanic ash, ground blast furnace slag, calcined or partially calcined clay, aluminum-containing silica fume, natural aluminosilicate, synthetic aluminosilicate glass powder, zeolite, scoria, allophone, bentonite, red mud, calcined red mud, pumice, or a combination thereof.

6. The method of claim 1, wherein the dry geopolymer precursor further comprises soda-lime glass dust, borosilicate glass dust, microsilica, fumed silica, precipitated silica, nanosilica, silica fume, rice husk ash, or a combination thereof.

7. The method of claim 1, wherein the dry geopolymer precursor further comprises a retarder selected from the group consisting of boric acid, glucoheptonic acid and soluble salts thereof, gluconic acid and soluble salts thereof, tartaric acid and soluble salts thereof, citric acid and soluble salts thereof, phosphoric acid and soluble salts thereof, sodium pentaborate decahydrate, borax, sucrose, lignosulphonates, and combinations thereof.

8. The method of claim 1, wherein the dry geopolymer precursor further comprises a viscosifier selected from the group consisting diutan gum, welan gum, a polyanionic cellulose (PAC), a carboxymethylcellulose (CMC), and combinations thereof.

9. The method of claim 1, wherein the dry geopolymer precursor further comprises one or more accelerators, density modifiers, antifoam agents, viscosifiers, defoamers, silica, fluid-loss control additives, dispersants, expanding agents, anti-settling additives or combinations thereof.

10-30. (canceled)

31. A dry geopolymer precursor that reacts with a non-activating water material to form a geopolymer material, the dry geopolymer precursor comprising an aluminosilicate source and a solid activator.

32. The dry geopolymer precursor of claim 31, wherein the dry geopolymer precursor is hydroxide-free.

33. The dry geopolymer precursor of claim 31, further comprising a retarder, an accelerator, an antifoam agent, a defoamer, silica, a fluid-loss control additive, a viscosifier, a dispersant, an expanding agent, an anti-settling additive, a density modifier, or a combination thereof.

34. The dry geopolymer precursor of claim 31, wherein the solid activator is present at a concentration of 4 to 40 parts per hundred based on the weight of the dry geopolymer precursor.

35. (canceled)

36. The dry geopolymer precursor of claim 31, wherein the aluminosilicate source is ground granulated blast furnace slag, ASTM Class C fly ash, or a mixture thereof.

37. The dry geopolymer precursor of claim 31, wherein the solid activator is soda ash, sodium metasilicate, or a combination thereof.

38-40. (canceled)

41. A method, comprising:
obtaining a dry geopolymer precursor comprising an aluminosilicate source and an activator;
mixing the dry geopolymer precursor with a non-activating water material to form a geopolymer slurry;
disposing the geopolymer slurry at a setting location; and
hardening the geopolymer slurry into a solid geopolymer at the setting location.

42. The method of claim 41, wherein the dry geopolymer precursor is hydroxide-free.

43. The method of claim 41, wherein the aluminosilicate source is GGBS and the activator is soda ash, and the dry geopolymer precursor further comprises a defoamer, a viscosifier, and a dispersant.

44. The method of claim 41, wherein the activator is selected from the group consisting of M₂CO₃, M₂SO₄, M₂SO₃, M₃PO₄, M₂C₂O₄, M₂ₓSi_{y}O_{2y+x} where x is 1, 2, or 3 and y is 1 or 2, MF, M₂SiF₆, MIO₃, M₂MoO₄, where M is Li, Na, K, Rb, or Cs, or a combination thereof.

45. The method of claim 44, wherein the aluminosilicate source is at least 15% by weight calcium oxide.
